(19) United States
(12) Patent Application Publication
(10) Pub. No.: US 2026/0191265 A1
(43) Pub. Date: Jul. 9, 2026

(54) HEATER, ATOMIZER AND AEROSOL GENERATION DEVICE

(71) Applicant: SHENZHEN FIRST UNION TECHNOLOGY CO., LTD., Shenzhen, Guangdong (CN)

(72) Inventors: Liangjie SU, Shenzhen, Guangdong (CN); Ruilong HU, Shenzhen, Guangdong (CN); Wenqiang HUANG, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 19/128,887

(22) PCT Filed: Oct. 31, 2023
(86) PCT No.: PCT/CN2023/128519

§ 371 Date: May 9, 2025

(30) Foreign Application Priority Data
Nov. 9, 2022 (CN) 202222981635.7

(51) Int. Cl. A24F 40/44; A24F 40/10; A24F 40/46; H05B 3/40

(52) U.S. Cl. CPC A24F 40/44; A24F 40/10; A24F 40/46; H05B 3/40

(57) ABSTRACT

A heater, an atomizer and an aerosol generation device are provided. The atomizer includes a liquid storage cavity used for storing a liquid substrate; a porous liquid guide body, including a first end and a second end longitudinally opposite each other and an outer side surface extending between the first end and the second end; a heating element bonded to the porous liquid guide body and used for atomizing a liquid substrate absorbed by the porous liquid guide body; and sealing elements surrounding parts of the outer side surface of the porous liquid guide body. The outer side surface of the porous liquid guide body is provided with a ventilation groove. The ventilation groove includes a first portion and a second portion, which are in communication with each other.

### CROSS-REFERENCE TO RELATED APPLICATIONS

This application claims priority to Chinese Patent Application No. 202222981635.7, entitled “HEATER, ATOMIZER AND AEROSOL GENERATION DEVICE” filed with the China National Intellectual Property Administration on Nov. 9, 2022, which is incorporated herein by reference in its entirety.

### TECHNICAL FIELD

Embodiments of this application relate to the field of aerosol generation devices, and in particular, to a heater, an atomizer, and an aerosol generation device.

### BACKGROUND

An aerosol generation device includes an atomizer and a power supply assembly. A heating element is arranged in the atomizer, and the heating element heats, atomizes, and volatilizes a liquid substrate to form smoke. When the liquid substrate in a liquid storage cavity of the atomizer is atomized to form smoke to escape, a negative pressure is formed in the liquid storage cavity due to consumption of the liquid substrate, and therefore the interior of the liquid storage cavity needs to be compensated for with air to balance the pressure.

In the prior art, a cylindrical ceramic atomizer is usually in two air intake modes, that is, fiber cotton with a breathable function is arranged outside a ceramic, or a ventilation groove is provided in a seal member used for sealing a ceramic liquid guide body. The mode in which the fiber cotton is wrapped outside the cylindrical ceramic requires manual wrapping with cotton, which makes it difficult to achieve automatic assembly. The providing of the ventilation groove in the seal member is to groove in flexible silicone, and the ventilation groove is deformed due to squeezing in mounting, which leads to an unstable dimension of the mounted ventilation groove, so that air supplement efficiency of different batches of products is inconsistent, and there are also risks of liquid leakage and smell of something burnt.

### SUMMARY

To solve the problem that it is difficult to provide a ventilation channel inside an atomizer in the prior art, an embodiment of this application provides an atomizer, including:
a liquid storage cavity for storing a liquid substrate;
a porous liquid guide body, which is in fluid communication with the liquid storage cavity to absorb the liquid substrate, and includes a first end and a second end longitudinally opposite each other, and an outer side surface extending between the first end and the second end;
a heating element, which is bonded to the porous liquid guide body and is used for atomizing a liquid substrate absorbed by the porous liquid guide body; and
sealing elements surrounding parts of the outer side surface of the porous liquid guide body, where
the outer side surface of the porous liquid guide body is provided with a ventilation groove, the ventilation groove includes a first portion and a second portion which are in communication with each other, the first portion is covered by the sealing element, at least a part of the second portion is not covered by the sealing element, and the second portion is in communication with the liquid storage cavity.

In some embodiments, the porous liquid guide body includes a first section and a second section with different outer diameters, a stepped surface is formed between the first section and the second section, and the stepped surface is used for fixing the sealing element.

In some embodiments, the first portion extends on the first section, and the second portion extends on the second section.

In some embodiments, the first portion extends non-linearly in a longitudinal direction.

In some embodiments, the ventilation groove has a depth ranging from 0.05 mm to 0.4 mm, or the ventilation groove has a width ranging from 0.1 mm to 0.6 mm.

In some embodiments, the first portion has a width not less than that of the second portion, or the first portion has a depth not less than that of the second portion.

In some embodiments, the sealing element includes a first sealing element and a second sealing element, and the first sealing element and the second sealing element have a longitudinal interval therebetween when mounted on the porous liquid guide body.

In some embodiments, the porous liquid guide body includes a first section and a second section with an outer diameter greater than that of the first section, at least a part of an outer side surface of the first section of the porous liquid guide body is not surrounded by the sealing element, and the part of the first section not surrounded by the sealing element is configured to be in direct contact with the liquid substrate.

In some embodiments, a range in which the heating element extends in the longitudinal direction of the porous liquid guide body at least partially coincides with a range in which the second portion of the ventilation groove extends in a longitudinal direction.

An embodiment of this application further provides an aerosol generation device, including the above-mentioned atomizer and a power supply assembly for providing electric drive for the atomizer.

An embodiment of this application further provides a heater for an aerosol generation device, including a porous liquid guide body for storing and delivering a liquid substrate and a heating element bonded to the porous liquid guide body, where the porous liquid guide body is configured to have a hollow tubular structure, an outer side surface of the porous liquid guide body is provided with a ventilation groove, the ventilation groove includes a first portion and a second portion which are in communication with each other, and the first portion has a depth not less than that of the second portion, or the first portion has a width not less than that of the second portion.

This application has the following beneficial effects. In the atomizer, the porous liquid guide body is provided with the ventilation groove, and the porous liquid guide body is preferably made of a hard porous ceramic material. Therefore, a dimension of the ventilation groove is stable and is not affected by assembly, thereby achieving a consistent ventilation effect and facilitating automatic assembly. Moreover, since the second portion, which is in communication with the liquid storage cavity, of the ventilation groove is not blocked by the sealing element arranged on the porous liquid guide body, it can be ensured that the ventilation groove is always kept in communication with the liquid storage cavity. Therefore, the atomizer has a continuous and stable ventilation effect, so that the liquid substrate of the atomizer can be smoothly supplied to the heating element, thereby effectively solving the problems of smell of something burnt and liquid leakage.

### BRIEF DESCRIPTION OF THE DRAWINGS

One or more embodiments are exemplarily described with reference to corresponding figures in the accompanying drawings, and the descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a schematic structural diagram of an aerosol generation device according to an embodiment of this application;

FIG. 2 is a sectional view of an atomizer according to an embodiment of this application;

FIG. 3 is an exploded view of an atomizer according to an embodiment of this application;

FIG. 4 is a perspective view of a heater according to an embodiment of this application;

FIG. 5 is a perspective view of a porous liquid guide body according to an embodiment of this application;

FIG. 6 is a sectional view of a sealing element according to an embodiment of this application; and

FIG. 7 is a sectional view of a heater according to an embodiment of this application.

### DETAILED DESCRIPTION

For ease of understanding of this application, this application is described below in more detail with reference to accompanying drawings and specific implementations.

It should be noted that all directional indications (such as up, down, left, right, front, rear, horizontal, and vertical) in the embodiments of this application are only used for explaining a relative position relationship, a movement status, or the like between components in a specific posture (as shown in the accompanying drawings). If the specific posture changes, the directional indications correspondingly change. The “connection” may be a direct connection or an indirect connection, and the “arrangement”, “arranged on”, and “arranged to” may be a direct arrangement or an indirect arrangement.

In addition, the descriptions involving “first”, “second”, and the like in this application are used for description only and cannot be construed as indicating or implying relative importance or implicitly indicating the number of technical features indicated. Therefore, the features defined with “first” and “second” may explicitly or implicitly include at least one of the features.

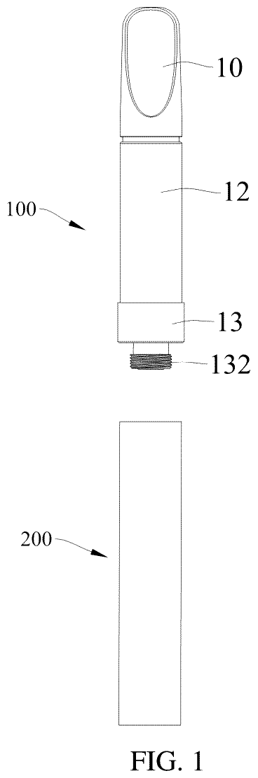

An embodiment of this application provides an aerosol generation device. As shown in FIG. 1, the aerosol generation device includes an electrically connected atomizer 100 and a power supply assembly 200, where the power supply assembly 200 includes a battery and other power supply components to provide power drive for the atomizer 100. The atomizer 100 atomizes a liquid substrate stored therein to generate an aerosol. The power supply assembly 200 may be configured in any form in the prior art, and is not specifically limited in the embodiment part of this application.

According to different liquid substrates atomized by the atomizer 100, the aerosol generation device is defined as having different use values. When the liquid substrate mainly includes at least two of an atomization additive, a nicotine extract, and a flavor composition, the aerosol generation device is mainly used as an electronic cigarette to meet needs of a user for nicotine. When the liquid substrate mainly includes an atomization additive and an active functional component with medical and health care functions, the aerosol generation device may be used as a medical device, and a user achieves health care by inhaling an aerosol generated by the aerosol generation device. The aerosol generation device according to the embodiment of this application may use the above two liquid substrates. This is not limited herein.

The atomizer 100 and the power supply assembly 200 may be configured as two detachable independent assemblies, and the two assemblies may be configured in a detachable connection mode in the prior art such as threaded connection, magnetic connection, or snap-fit connection. The atomizer 100 is configured to be replaceable so as to supplement the liquid substrate, and the power supply assembly 200 is configured to be sustainable.

In an embodiment of this application, referring to FIG. 1, a threaded sleeve 131 is arranged on an end portion of the atomizer 100, and a threaded groove is provided at one end of the power supply assembly 200. The two assemblies are connected by threads. Moreover, both a connecting end portion of the atomizer 100 and a connecting end portion of the power supply assembly 200 are provided with electrical connection assemblies, so that after the two assemblies are connected, the two assemblies are in electrical communication with each other. In another alternative example, the atomizer and the power supply assembly may be accommodated in a housing to form an integrated aerosol generation device. Such an aerosol generation device has a relatively small volume and is convenient to carry.

In the following section, a structure of a roughly cylindrical atomizer 100 is taken as an example to explain the internal structure of the atomizer 100. It may be understood that the atomizer may be arranged in a flat shape or another shape.

Referring to FIG. 1 to FIG. 3, the atomizer 100 includes a housing. The housing may be formed by combining a plurality of sub-housings, and the sub-housings may be made of different materials. Sealing connecting components are arranged between the sub-housings.

The housing includes a suction nozzle 10, a liquid storage sleeve 12, and a base 13. The suction nozzle 10 is made of a food-grade plastic material, and a flat vaping portion is arranged on the suction nozzle 10. The vaping portion is provided with a suction nozzle opening 110 in communication with an inner cavity of the vaping portion. A user is mainly in contact with the vaping portion when using the aerosol generation device, and an aerosol generated in the atomizer escapes through the suction nozzle opening 110 to be inhaled by the user.

The liquid storage sleeve 12 is made of a hard transparent plastic material or a glass material and is roughly tubular, and the suction nozzle 10 and the base 13 are hermetically connected to both ends of the liquid storage sleeve 12 respectively. A part of an inner cavity of the liquid storage sleeve 12 is defined to form a liquid storage cavity 121, which is used for storing the liquid substrate. To prevent the detachment of the suction nozzle 10 from one end of the liquid storage sleeve 12, which exposes an end portion of the liquid storage cavity 121, and is not conducive to safe use of the atomizer 100, an anti-disassembly structure may be further arranged between the suction nozzle 10 and the liquid storage sleeve 12.

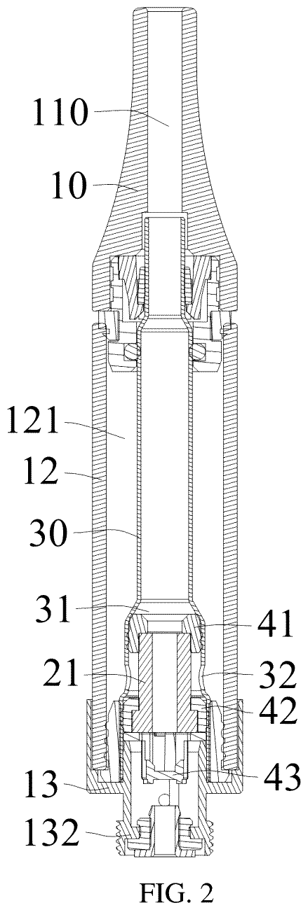

The base 13 is preferably made of a hard plastic material or metal material. The base 13 is used for closing an opening at a bottom end of the liquid storage sleeve 12. As shown in FIG. 2, the base 13 includes an annular accommodating groove 131, and at least a part of the liquid storage sleeve 12 is inserted into the accommodating groove 131 through an open end of the accommodating groove 131.

The base 13 further includes a threaded electrode 132, and the threaded electrode 132 is configured to be electrically connected to the power supply assembly 200.

The atomizer 100 further includes a heater, and the heater is configured to atomize the liquid substrate inside the liquid storage cavity to generate an aerosol. In an embodiment of this application, the heater includes a porous liquid guide body 21 and a heating element 22. The porous liquid guide body 21 is in fluid communication with the liquid substrate inside the liquid storage cavity, to absorb the liquid substrate, and the heating element 22 is bonded to the porous liquid guide body 21 to atomize the liquid substrate.

The porous liquid guide body 21 is roughly columnar and is made of a hard porous material. Because of an internal porous structure, the porous liquid guide body 21 can deliver and store the liquid substrate. In an example, the porous material for forming the porous liquid guide body 21 includes a hard porous material such as a microporous ceramic, a microporous glass ceramic, microporous glass, or a foam metal.

The porous liquid guide body 21 has a hollow inner cavity, and the heating element 22 is arranged in the inner cavity of the porous liquid guide body 21. The heating element 22 is made of a raw material which may be a metal material, a metal alloy, graphite, carbon, a conductive ceramic or another composite material of a ceramic material and a metal material, with appropriate impedance. An appropriate metal or alloy material includes at least one of nickel, cobalt, zirconium, titanium, a nickel alloy, a cobalt alloy, a zirconium alloy, a titanium alloy, a nickel chromium alloy, a nickel iron alloy, an iron chromium alloy, an iron manganese aluminum-based alloy, or stainless steel, and the like. In an example, the heating element 22 is configured as a heating wire extending spirally, and the heating wire is embedded in an inner wall of the porous liquid guide body 21 during molding of the porous liquid guide body 21. The heating element 22 extends spirally roughly in the longitudinal direction of the porous liquid guide body 21. In another alternative example, the heating element 22 may alternatively be configured as a heating film or a heating mesh with a grid structure. In another alternative example, the heating element 22 may be made of a susceptor material capable of generating heat by an eddy current or a hysteresis effect under an alternating magnetic field.

The atomizer 100 further includes a bracket 30, and the bracket 30 is formed by stretching a metal material to form a tubular member with a hollow inner cavity. A part of the inner cavity of the bracket 30 forms an accommodating cavity 31 for accommodating the above-mentioned heater.

In the cylindrical atomizer, the inner cavity of the bracket 30 is not only used for accommodating the heater, but also configured as a fluid channel. Specifically, the bracket 30 has a proximal end and a distal end which are longitudinally opposite. The proximal end of the bracket 30 extends into an inner cavity of the suction nozzle 10, and the distal end of the bracket 30 extends into an inner cavity of the base 13. External airflow enters the inner cavity of the bracket 30 from an air inlet in the base 13 and a distal end opening of the bracket 30 to be provided to the heating element 22. An aerosol generated through atomization by the heating element 22 passes through the inner cavity of the bracket 30 to enter the suction nozzle opening 110 from a proximal end opening of the bracket 30 to escape from the suction nozzle opening 110.

The bracket 30 extends in a longitudinal direction thereof for a sufficient length so that the proximal end thereof is inserted into the suction nozzle 10, and the distal end thereof is inserted into the accommodating groove of the base 13 and supported by the base 13. In addition, to facilitate the fixing of the bracket 30 and the heater, the bracket 30 is configured as a multi-section longitudinally extending tubular member, and sections have different inner diameters and outer diameters, so that an inner stepped surface and an outer stepped surface are formed between two adjacent sections. This facilitates the fixing and positioning between the bracket 30 and the suction nozzle 10, between the bracket 30 and the base 13, and between the bracket 30 and the heater. The inner diameter and the outer diameter of the bracket 30 gradually increase from the proximal end to the distal end, thereby facilitating fitting and connection between components.

The bracket 30 is further provided with a hole 32, and the liquid substrate in the liquid storage cavity 121 enters the accommodating cavity 31 through the hole 32, so as to be supplied to the porous liquid guide body 21. In an example of this application, a plurality of holes 32 are provided in the bracket 30, and the plurality of holes 32 are evenly provided at intervals in a circumferential direction of the bracket 30. Because the porous liquid guide body 21 is roughly columnar, the liquid substrate can enter the accommodating cavity 31 at a uniform speed through the holes 32.

The atomizer 100 further includes a sealing element 40, and the porous liquid guide body 21 is mounted inside the accommodating cavity 31 through the sealing element 40.

In an embodiment of this application, an atomizer 100 with a novel structure is provided. A part of an outer side surface of the porous liquid guide body 21 is in direct contact with the liquid substrate in the liquid storage cavity 121, so that a process of delivery through liquid guide cotton is omitted, thereby effectively solving the problem that liquid guide performance of the atomizer is different due to inconsistent tightness of manual wrapping with cotton on the outer side surface of the porous liquid guide body 21. In the cylindrical porous liquid guide body 21, the porous liquid guide body 21 has the outer side surface and an inner side surface that are laterally opposite, and the heating element 22 is embedded in an inner surface of the porous liquid guide body 21. The liquid substrate can penetrate into the porous liquid guide body 21 from the outer side surface of the porous liquid guide body 21 to be supplied to the heating element 22 through the inner side surface of the porous liquid guide body 21. There is no liquid guide cotton on the outer side surface of the porous liquid guide body 21. Therefore, the liquid substrate inside the liquid storage cavity 121 is directly supplied to the heating element 22 by the porous liquid guide body 21, so that the liquid guide performance of the entire atomizer is mainly determined by the liquid guide capability of the porous liquid guide body 21, and high consistency in liquid guide performance of the entire atomizer can be maintained compared with when the liquid guide cotton is wound around the outer side surface of the porous liquid guide body 21.

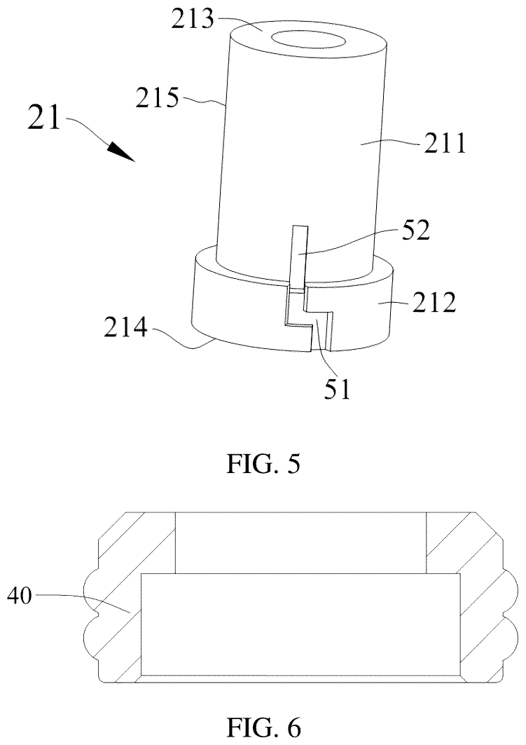

The porous liquid guide body 21 may be configured as a conventional cylindrical structure, or the porous liquid guide body 21 may be configured as an unconventional cylindrical structure. For example, the porous liquid guide body 21 is configured to have a plurality of sections with different outer diameters, so that a plurality of stepped surfaces can be formed on the outer side surface of the porous liquid guide body 21, and the stepped surfaces facilitate sealing on the outer side surface of the porous liquid guide body 21. In an example of this application, referring to FIG. 5, the porous liquid guide body 21 is divided into a first section 211 and a second section 212 in the longitudinal direction thereof. The first section 211 has a longitudinal length greater than that of the second section 212, and the first section 211 has an outer diameter smaller than that of the second section 212, so that the second section 212 protrudes relative to the first section 211.

Further, referring to FIG. 2 to FIG. 4, at least a part of an outer side surface of the first section 211 of the porous liquid guide body 21 is configured to be in direct contact with the liquid substrate. That is, the liquid substrate in the liquid storage cavity 121 enters, through a plurality of liquid guide holes in the bracket 30, an annular liquid storage space defined by the inner side surface of the bracket 30 and a part of the outer side surface of the porous liquid guide body 21, and a part of the outer side surface of the porous liquid guide body 21 is surrounded by the liquid storage space. Therefore, the liquid substrate can be directly supplied to the porous liquid guide body 21 without being delivered through another liquid guide medium, thereby effectively improving liquid guide efficiency.

The porous liquid guide body 21 includes a first end 213 and a second end 214 longitudinally opposite each other, and an outer side surface 215 extending between the first end 213 and the second end 214. The first end 213 of the porous liquid guide body 21 is closer to the suction nozzle opening 110 than the second end 214. A first sealing element 41 and a second sealing element 42 are arranged at the first end 213 and the second end 214 of the porous liquid guide body 21 respectively. The first sealing element 41 and the second sealing element 42 have a longitudinal interval therebetween when mounted on the porous liquid guide body 21, that is, the outer side surfaces of both ends of the porous liquid guide body 21 are surrounded by the first sealing element 41 and the second sealing element 42 respectively, while an outer side surface of a middle part of the porous liquid guide body 21 is configured to be in direct contact with the liquid substrate. The first sealing element 41 and the second sealing element 42 are arranged on the outer side surfaces of an upper end portion and a lower end portion of the porous liquid guide body 21, so that effective seals are formed on the two end portions of the porous liquid guide body 21 to prevent liquid leakage.

The first sealing element 41 and the second sealing element 42 each may be made of at least one of a fiber material or a flexible silicone material or a thermoplastic elastomer (TPE). The first sealing element 41 and the second sealing element 42 may be made of the same material, or the first sealing element 41 and the second sealing element 42 may be made of different materials.

In some examples, the first sealing element 41 and the second sealing element 42 each are made of an integrally formed flexible silicone material or polymer fiber cotton material, and the first sealing element 41 and the second sealing element 42 can be directly sleeved at both ends of the porous liquid guide body 21, thereby facilitating automatic assembly of the atomizer and improving assembly efficiency. In another alternative embodiment, the first sealing element 41 and the second sealing element 42 are made of sheet-like fiber cotton cloth and are wrapped and wound around the outer side surface of the porous liquid guide body 21 manually.

It should be noted that, when the first sealing element 41 and the second sealing element 42 each are made of an integrally formed flexible silicone material or polymer fiber cotton material, the outer side surface of the porous liquid guide body 21 is provided with at least one stepped surface or groove. This facilitates the fixing of the sealing elements. When the first sealing element 41 and the second sealing element 42 are made of sheet-like cotton fiber in a wrapped and wound mode or an integrally formed polymer cotton fiber material, the outer side surface of the porous liquid guide body 21 may be configured as a flat outer surface, and the heater with the first sealing element 41 and the second sealing element 42 being fixed can be mounted into the inner cavity of the bracket 30 through flexibility of the cotton fiber material.

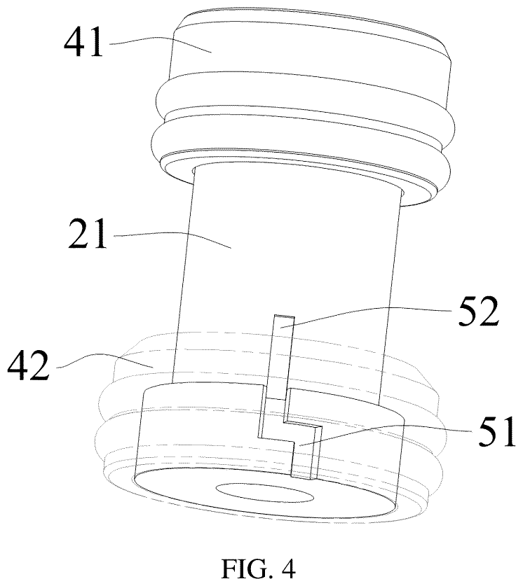

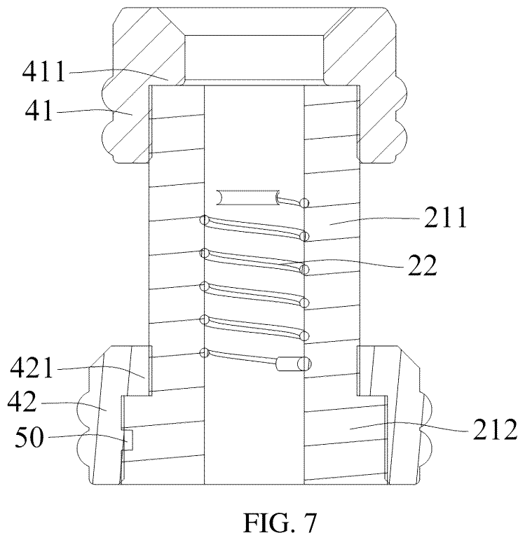

Further, referring to FIG. 4 and FIG. 7, in an example, the first sealing element 41 and the second sealing element 42 each are made of a flexible silicone material to form an annular sleeve. A first flange 411 is arranged on an inner side wall of the first sealing element 41, and a second flange 421 is arranged on an inner side wall of the second sealing element 42. This flange structure helps to form an interference fit between the first sealing element 41 and the porous liquid guide body 21 and between the second sealing element 42 and the porous liquid guide body, thereby preventing the first sealing element 41 and the second sealing element 42 from sliding on the porous liquid guide body 21 or even falling off the porous liquid guide body.

The porous liquid guide body 21 includes a first section 211 and a second section 212, where a stepped surface is formed between the second section 212 and the first section 211. The first flange 411 of the first sealing element 41 longitudinally abuts against an end surface of the first end 213 of the porous liquid guide body 21, and the second flange 412 of the second sealing element 42 longitudinally abuts against the stepped surface of the porous liquid guide body 21, so that the first sealing element 41 and the second sealing element 42 can be firmly fixed to the porous liquid guide body 21.

In the above example, the outer diameter of the first section 211 is smaller than that of the second section 212. The first sealing element 41 is fixed to the first section 211, and the second sealing element 42 is fixed to the second section 212. The inner diameter and the outer diameter of the first sealing element 41 are smaller than those of the second sealing element 42.

Both the first sealing element 41 and the second sealing element 42 are arranged in a ring shape and are roughly in central symmetry, so that the first sealing element 41 and the second sealing element 42 can be mounted on the porous liquid guide body 21 at any mounting angle. This facilitates blind mounting of the first sealing element 41 and the second sealing element 42, thereby improving mounting efficiency of the first sealing element 41 and the second sealing element 42.

To prevent the formation of a negative pressure in the liquid storage cavity 121, which prevents the liquid substrate from being supplied to the porous liquid guide body 21, in an embodiment of this application, the outer side surface of the porous liquid guide body 21 is provided with a ventilation groove 50. One end of the ventilation groove 50 is in communication with external airflow, and the other end of the ventilation groove 50 is in communication with the liquid storage cavity 121, so that the external airflow can be introduced into the liquid storage cavity 121, thereby preventing the formation of the negative pressure. Compared with the arrangement of a ventilation structure on the first sealing element 41 or the second sealing element 42, the provision of the ventilation groove 50 in the porous liquid guide body 21 can prevent the ventilation groove 50 from being squeezed by assembly, which otherwise affects the ventilation capability of the ventilation groove.

Further, referring to FIG. 5, the ventilation groove 50 includes a first portion 51 and a second portion 52 which are in communication with each other. The second portion 52 is closer to the liquid storage cavity 121 than the first portion 51. When viewed from the outer side surface of the porous liquid guide body 21, an outer side opening of the first portion 51 is covered by the sealing element, and the second portion 52 is not covered by the sealing element, so that the second portion 52 is always in communication with the liquid storage cavity 121, thereby enabling the ventilation groove 50 to always have the ventilation capability.

The first portion 51 is closer to an air inlet channel of the atomizer 100 than the second portion 52. The first portion 51 is in communication with the air inlet channel inside the atomizer 100, and external airflow sequentially passes through the first portion 51 and the second portion 52 of the ventilation groove 50 to enter the liquid storage cavity 121.

In some embodiments, the first portion 51 extends non-linearly in the longitudinal direction, and the second portion 52 may extend non-linearly or linearly in the longitudinal direction. For example, the ventilation groove 50 of the first portion 51 may longitudinally extend in a Z shape, an S shape, a zigzag shape, or spirally. The arrangement of the ventilation groove 50 of the first portion 51 to extend non-linearly prevents the liquid substrate from leaking through the ventilation groove 50. Even if the second portion 52 is arranged to extend linearly, the liquid substrate leaked through the ventilation groove 50 of the second portion 52 is blocked by a non-linear extending wall of the first portion 51. This can effectively reduce the leakage of the liquid substrate.

In some embodiments, the ventilation groove 50 has an appropriate depth and width, so that the ventilation groove 50 has a better ventilation effect. The depth of the ventilation groove 50 is defined as a distance between a bottom wall of the ventilation groove 50 and the outer side surface of the porous liquid guide body 21, and the width of the ventilation groove 50 is defined as a distance between two side walls of the ventilation groove 50. The range of the length by which the ventilation groove 50 extends in the longitudinal direction is not limited in the embodiment of this application, and can be adaptively adjusted according to the length range of the entire porous liquid guide body 21.

The ventilation groove 50 has a proper depth ranging from 0.05 mm to 0.4 mm. In a specific implementation, the depth of the ventilation groove 50 may be defined as any value between 0.05 mm and 0.4 mm, such as 0.05 mm, 0.1 mm, 0.2 mm, 0.25 mm, 0.3 mm, 0.35 mm, or 0.4 mm.

The ventilation groove 50 has a proper width ranging from 0.1 mm to 0.6 mm. In a specific implementation, the depth of the ventilation groove 50 may be defined as any value between 0.1 mm and 0.6 mm, such as 0.1 mm, 0.2 mm, 0.25 mm, 0.3 mm, 0.4 mm, 0.5 mm, or 0.6 mm.

In some embodiments, the first portion 51 has a depth not less than that of the second portion 52, and/or the first portion 51 has a width not less than that of the second portion 52, so that the ventilation groove 50 of the first portion 51 has a larger volume space than the ventilation groove 50 of the second portion 52. On the one hand, the ventilation groove 50 of the first portion 51 can allow more airflow to enter, so that more sufficient airflow can enter the second portion 52. On the other hand, the first portion 51 has more volume space to store more leaked liquid substrate, and can achieve the function of a ventilation channel thereof.

In some embodiments, referring to FIG. 4 and FIG. 7, an area in which the ventilation groove 50 extends in the longitudinal direction of the porous liquid guide body 21 at least partially coincides with an area in which the heating element 22 extends in the longitudinal direction of the porous liquid guide body 21, so that at least a part of the ventilation channel is close to a heating area. This can facilitate delivery of the liquid substrate stored in the porous liquid guide body 21 to the heating element 22, and facilitate solving of the problems of smell of something burnt and liquid leakage.

In the above example, the ventilation groove 50 is provided close to the second end 214 of the porous liquid guide body 21, and the ventilation groove 50 is in communication with the air inlet channel inside the atomizer. In another alternative example, the ventilation groove 50 may be provided close to the first end 213 of the porous liquid guide body 21, and the ventilation groove 50 is in communication with an air outlet channel inside the atomizer.

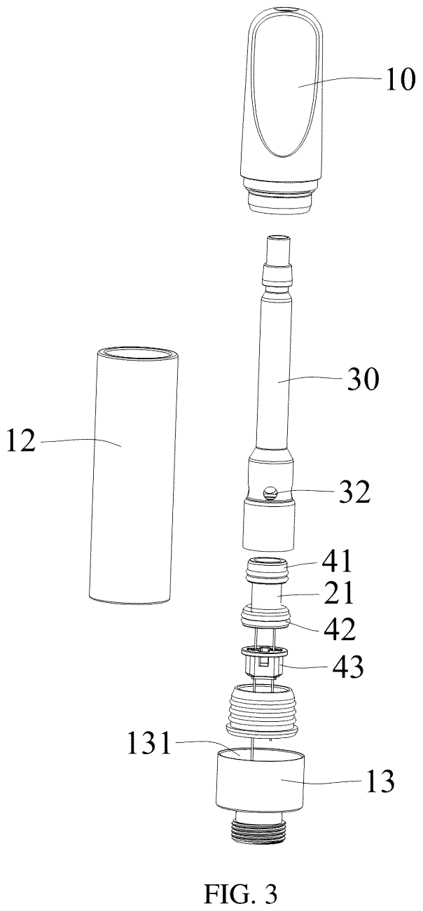

Further, referring to FIG. 2 and FIG. 3, the atomizer 100 internally further includes a supporting member 43. The supporting member 43 is fixed in the inner cavity of the base 13, to provide longitudinal support for the porous liquid guide body 21. The supporting member 43 may be made of a hard plastic material or a flexible silicone material. When the supporting member 43 and the second sealing element 42 are made of the same silicone material, the two components may be configured as one component. The second sealing element 42 forms a seal on the outer side surface of the second end 214 of the porous liquid guide body 21, and the supporting member 43 further seals a bottom end surface of the second end 214 of the porous liquid guide body 21.

It should be noted that, the specification of this application and the accompanying drawings thereof illustrate preferred embodiments of this application, but this application is not limited to the embodiments described in this specification. Further, for a person of ordinary skill in the art, improvements or modifications may be made according to the above-mentioned descriptions, and all these improvements and modifications shall fall within the protection scope of the appended claims of this application.

1. An atomizer, comprising:
a liquid storage cavity for storing a liquid substrate;
a porous liquid guide body, which is in fluid communication with the liquid storage cavity to absorb the liquid substrate, and comprises a first end and a second end longitudinally opposite each other, and an outer side surface extending between the first end and the second end;
a heating element, which is bonded to the porous liquid guide body and is used for atomizing a liquid substrate absorbed by the porous liquid guide body; and
sealing elements surrounding parts of the outer side surface of the porous liquid guide body,
wherein the outer side surface of the porous liquid guide body is provided with a ventilation groove, the ventilation groove comprises a first portion and a second portion which are in communication with each other, the first portion is covered by the sealing element, at least a part of the second portion is not covered by the sealing element, and the second portion is in communication with the liquid storage cavity.

2. The atomizer according to claim 1, wherein the porous liquid guide body comprises a first section and a second section with different outer diameters, a stepped surface is formed between the first section and the second section, and the stepped surface is used for fixing the sealing element.

3. The atomizer according to claim 2, wherein the first portion extends on the first section, and the second portion extends on the second section.

4. The atomizer according to claim 3, wherein the first portion extends non-linearly in a longitudinal direction.

5. The atomizer according to claim 1, wherein the ventilation groove has a depth ranging from 0.05 mm to 0.4 mm, or the ventilation groove has a width ranging from 0.1 mm to 0.6 mm.

6. The atomizer according to claim 1, wherein the first portion has a width not less than that of the second portion, or the first portion has a depth not less than that of the second portion.

7. The atomizer according to claim 1, wherein the sealing element comprises a first sealing element and a second sealing element, and the first sealing element and the second sealing element have a longitudinal interval therebetween when mounted on the porous liquid guide body.

8. The atomizer according to claim 1, wherein the porous liquid guide body comprises a first section and a second section with an outer diameter greater than that of the first section, at least a part of an outer side surface of the first section of the porous liquid guide body is not surrounded by the sealing element, and the part of the first section not surrounded by the sealing element is configured to be in direct contact with the liquid substrate.

9. The atomizer according to claim 1, wherein a range in which the heating element extends in the longitudinal direction of the porous liquid guide body at least partially coincides with a range in which the second portion of the ventilation groove extends in a longitudinal direction.

10. An aerosol generation device, comprising the atomizer according to claim 1, and a power supply assembly for providing electric drive for the atomizer.

11. A heater for an aerosol generation device, comprising a porous liquid guide body for storing and delivering a liquid substrate and a heating element bonded to the porous liquid guide body, wherein the porous liquid guide body is configured to have a hollow tubular structure, an outer side surface of the porous liquid guide body is provided with a ventilation groove, the ventilation groove comprises a first portion and a second portion which are in communication with each other, and the first portion has a depth not less than that of the second portion, or the first portion has a width not less than that of the second portion.

12. The atomizer according to claim 5, wherein the first portion has a width not less than that of the second portion, or the first portion has a depth not less than that of the second portion.
